(19) United States
(12) Patent Application Publication
(10) Pub. No.: US 2020/0365344 A1
(43) Pub. Date: Nov. 19, 2020

(54) RETROFIT REGISTER CONTROL SYSTEM

(71) Applicant: AIR DISTRIBUTION TECHNOLOGIES IP, LLC, Glendale, WI (US)

(72) Inventors: Rajesh Dushyantkumar VYAS, Vadodara (IN); Eric Wayne PALMBOS, Hudsonville, MI (US); Vikas Ashok PATIL, Jaysingpur (IN); Satyendra KUMAR, Patna (IN); Rahul JAIN, Pune (IN)

(21) Appl. No.: 16/516,994

(22) Filed: Jul. 19, 2019

Related U.S. Application Data
(60) Provisional application No. 62/847,623, filed on May 14, 2019.

(51) Int. Cl. H01H 3/60; H01H 3/32; H01H 3/04

(52) U.S. Cl. CPC H01H 3/605; H01H 3/04; H01H 3/32

(57) ABSTRACT

Aspects of the present disclosure include a damper control system having a casing configured to detachably couple from a conventional air register having a damper assembly movably controllable by a manual lever, a motor assembly mounted to the casing, an actuating linkage assembly movably attached to the motor assembly and configured to detachably couple with the manual lever that controls the damper assembly, wherein one or more dampers of the damper assembly are in a closed position when the actuating linkage assembly is in a first position and in an open position when the actuating linkage assembly is in a second position, a memory mounted within the casing, and one or more processors communicatively coupled with the memory and mounted within the casing, the one or more processors being configured to cause the motor assembly to drive the actuating linkage assembly between the first position and the second position.

### CROSS-REFERENCE TO RELATED APPLICATION

The current application claims priority to U.S. Provisional Application No. 62/847,623, filed on May 14, 2019, entitled RETROFIT REGISTER CONTROL SYSTEM, the contents of which are incorporated by reference in their entireties.

### BACKGROUND

Conventional air registers may be located throughout a structure to control delivery of air from an air handling unit into various areas of the structure. It may be desirable to control the air flow through each of the conventional air registers in order to properly control the temperature within the structure and/or conserve electrical energy and expenses. Conventional air registers utilize a manual lever to control the airflow through the register. Although some air registers are specially designed to include built-in automated damper control, these air registers are expensive. In order to update a structure with automated damper control, conventional air registers with manual damper control generally need to be replaced, which involves a lot of manual labor and, as noted, the use of expensive air registers with the built-in damper control system. In addition, such air registers with built-in automated damper control require an electrical outlet or separate electrical line to power such devices. Therefore, improvements in providing damper control to conventional air registers may be desirable.

### SUMMARY

This summary is provided to introduce a selection of concepts in a simplified form that are further described below in the DETAILED DESCRIPTION. This summary is not intended to identify key features of the claimed subject matter, nor is it intended to be used as an aid in determining the scope of the claimed subject matter.

An aspect of the present disclosure includes a damper control system having a casing configured to detachably couple from a conventional air register having a damper assembly movably controllable by a manual lever, a motor assembly mounted to the casing, an actuating linkage assembly movably attached to the motor assembly and configured to detachably couple with the manual lever that controls the damper assembly, wherein one or more dampers of the damper assembly are in a closed position when the actuating linkage assembly is in a first position and in an open position when the actuating linkage assembly is in a second position, a memory mounted within the casing, and one or more processors communicatively coupled with the memory and mounted within the casing, the one or more processors being configured to cause the motor assembly to drive the actuating linkage assembly between the first position and the second position.

Some aspects of the present disclosure includes an air register having a body including one or more brackets, a damper assembly mounted to the one or more brackets and having one or more dampers movably controllable by a manual lever, and a register control system removably attachable to the body, the register control system including: a casing configured to detachably couple from the body, a motor assembly mounted to the casing, an actuating linkage assembly movably attached to the motor assembly and configured to detachably couple with the manual lever of that controls the damper assembly, wherein the one or more dampers of the damper assembly are in a closed position when the actuating linkage assembly is in a first position and in an open position when the actuating linkage assembly is in a second position, a memory mounted within the casing, and one or more processors communicatively coupled with the memory and mounted within the casing, the one or more processors being configured to cause the motor assembly to drive the actuating linkage assembly between the first position and the second position.

Certain aspects of the present disclosure includes a method of controlling air flow including receiving a feedback signal from a register control system, wherein the register control system comprises: a casing configured to detachably couple from a conventional air register having a damper assembly controlled by a manual lever, a motor assembly mounted to the casing, an actuating linkage assembly movably connected to the motor assembly and configured to detachably couple with the manual lever that controls the damper assembly, wherein one or more dampers of the damper assembly are in a closed position when the actuating linkage assembly is in a first position and in an open position when the actuating linkage assembly is in a second position, a memory mounted within the casing, and one or more processors communicatively coupled with the memory and mounted within the casing, the one or more processors being configured to cause the motor assembly to drive the actuating linkage assembly between the first position and the second position, and transmitting a control signal to the register control system to cause the one or more dampers to move into a position between the closed position and the open position.

### BRIEF DESCRIPTION OF THE DRAWINGS

The features believed to be characteristic of aspects of the disclosure are set forth in the appended claims. In the description that follows, like parts are marked throughout the specification and drawings with the same numerals, respectively. The drawing figures are not necessarily drawn to scale and certain figures may be shown in exaggerated or generalized form in the interest of clarity and conciseness. The disclosure itself, however, as well as a preferred mode of use, further objects and advantages thereof, will be best understood by reference to the following detailed description of illustrative aspects of the disclosure when read in conjunction with the accompanying drawings, wherein:

FIG. 1 illustrates an example of an environment for retrofitting conventional air registers with damper control in accordance with aspects of the present disclosure;

FIG. 2 illustrates a conventional air register;

FIG. 3 illustrates a conventional air register with an example of a retrofitted damper control system in accordance with aspects of the present disclosure;

FIG. 4 illustrates an exploded view of an example of a retrofitted damper control system in accordance with aspects of the present disclosure;

FIG. 5A illustrates an example of a motorized lever assembly of the retrofitted damper control system in accordance with aspects of the present disclosure;

FIG. 5B illustrates an exploded view of the motorized lever assembly of the retrofitted damper control system in accordance with aspects of the present disclosure;

FIG. 6 illustrates an example of a functional diagram for controlling the air flow of a retrofitted air register;

FIG. 7 illustrates an example of a computer system in accordance with aspects of the present disclosure; and

FIG. 8 illustrates a method for controlling the air flow of a retrofitted air register in accordance with aspects of the present disclosure.

### DETAILED DESCRIPTION

The following includes definitions of selected terms employed herein. The definitions include various examples and/or forms of components that fall within the scope of a term and that may be used for implementation. The examples are not intended to be limiting.

The term “processor,” as used herein, can refer to a device that processes signals and performs general computing and arithmetic functions. Signals processed by the processor can include digital signals, data signals, computer instructions, processor instructions, messages, a bit, a bit stream, or other computing that can be received, transmitted and/or detected. A processor, for example, can include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described herein.

The term “bus,” as used herein, can refer to an interconnected architecture that is operably connected to transfer data between computer components within a singular or multiple systems. The bus can be a memory bus, a memory controller, a peripheral bus, an external bus, a crossbar switch, and/or a local bus, among others.

The term “memory,” as used herein, can include volatile memory and/or nonvolatile memory. Non-volatile memory can include, for example, ROM (read only memory), PROM (programmable read only memory), EPROM (erasable PROM) and EEPROM (electrically erasable PROM). Volatile memory can include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM).

Certain aspects of the present disclosure may include a register control system that may be retrofitted onto various conventional registers that are manually operated. The register control system may be attached to the conventional registers without any structural modification to the registers. The register control system may be attached to the conventional registers without impeding or substantially without impeding the air flow of the conventional registers. For example, after retrofitting the conventional register with the register control system, the air flow of the conventional register may be reduced by less than 10%, 5%, or 1% as per sizes. An aspect of the present disclosure may modify a manual conventional register to an automated register.

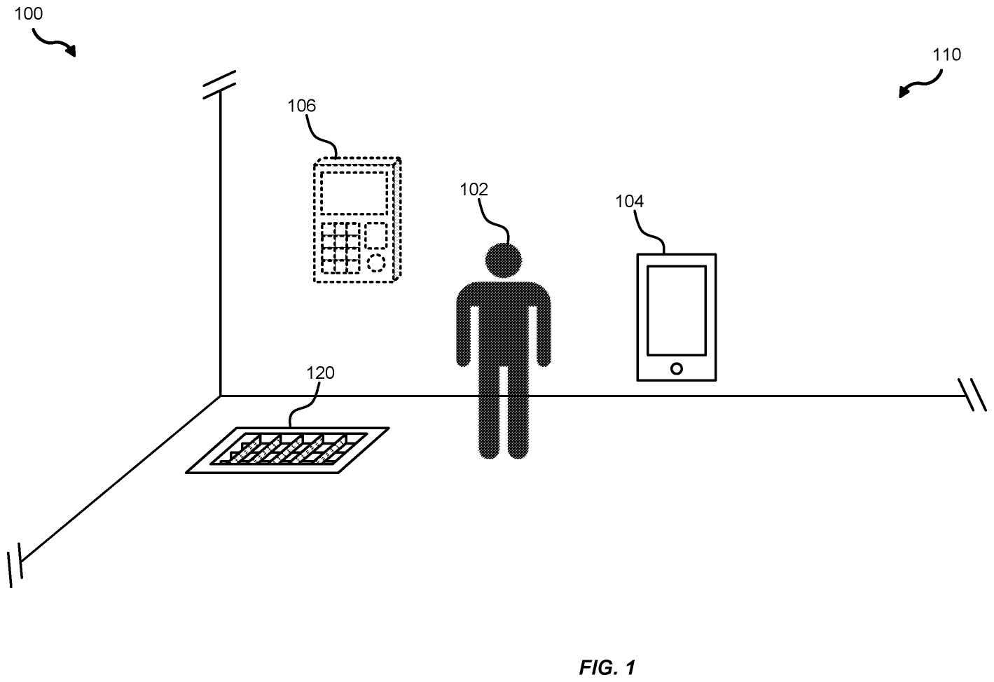

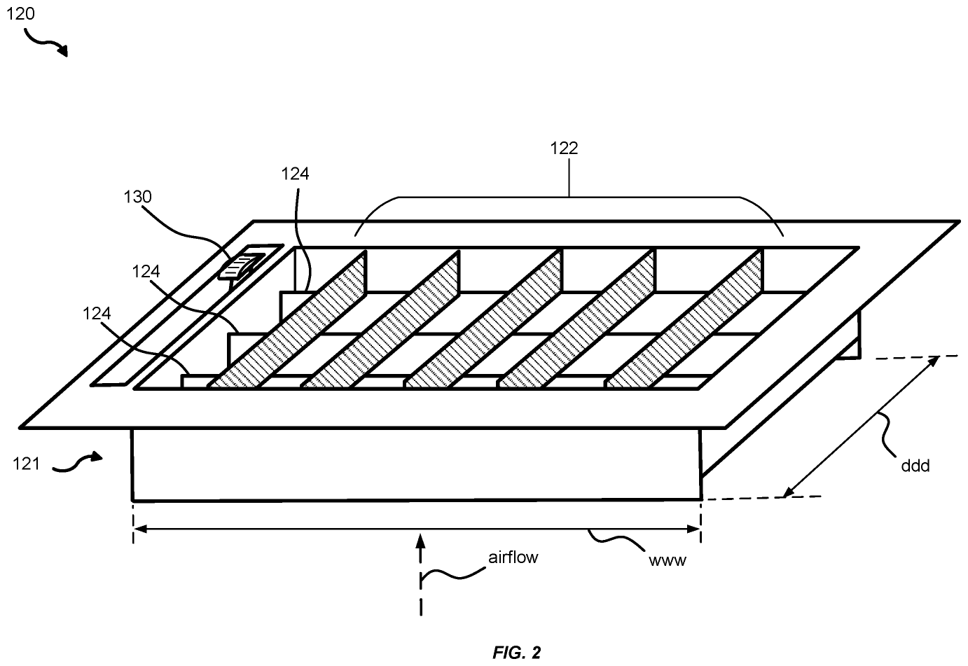

Turning now to FIGS. 1 and 2, in some aspects, an environment 100 may include a person 102, a handheld device 104, and an optional environment controller 106. The handheld device 104 may be a wireless device, a mobile phone, a cellular phone, a tablet computer, a personal digital assistant, a smartphone, or other portable devices capable of wireless communications. The handheld device 104 may be implemented as a computer system (example shown below). The environment controller 106 may include a thermostat and/or an alarm panel. The thermostat may be communicatively coupled with an air handling unit (not shown) that provides cold or warm air. The environment controller 106 may be communicatively coupled with (wired or wireless) remote server(s) of an alarm company, a security company, an alarm monitoring company, and/or an authority.

In some implementations, the environment 100 may include a room 110 including a conventional air register 120. The conventional air register 120 may include a body 121, a first set of dampers 122, a second set of dampers 124, and manual lever 130. The first set of dampers 122 may be stationary or adjustable. For example, each damper of the first set of dampers 122 may be individually adjustable. The second set of dampers 124 may be stationary or adjustable. For example, each damper of the second set of dampers 124 may be individually adjustable.

Specifically referring to FIG. 2, air may flow through the body 121, the first set of dampers 122, and the second set of dampers 124 of the conventional air register 120. By manually actuating the manual lever 130, the person 102 may adjust the amount of air flow through the conventional air register 120. For example, by completely closing the second set of dampers 124 using the manual lever 130, the person 102 may reduce or cutoff the air flow. The cross-sectional area of the air flow may be may be less than or equal to width www of the body 121 multiplied by depth ddd of the body 121. The second set of dampers 124, as controlled by the manual lever 130, may control the amount of air flow through the conventional air register 120 by changing the cross-sectional area of the air flow.

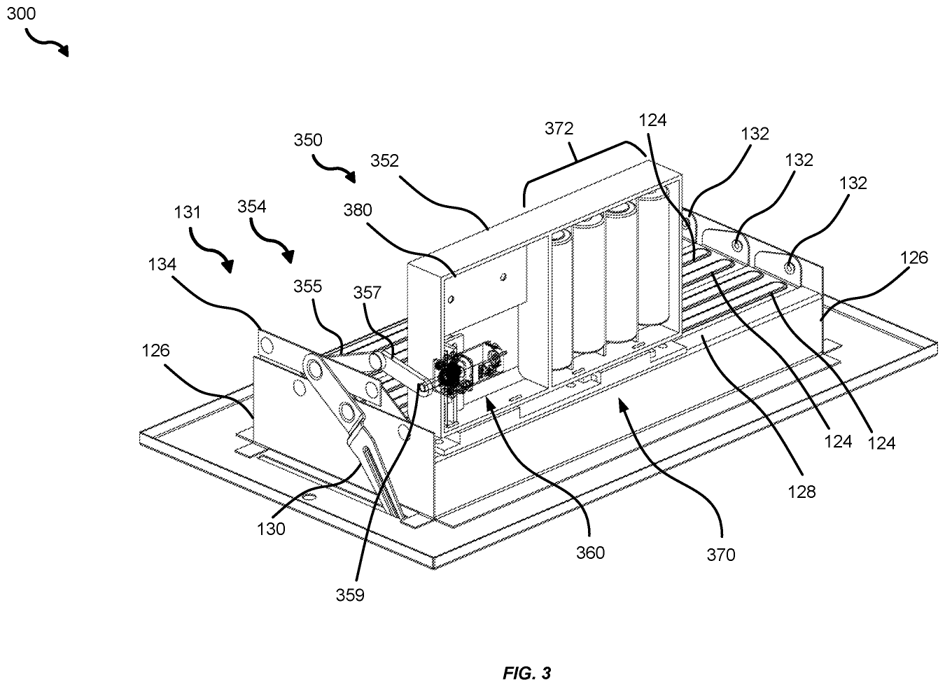

Turning now to FIG. 3, in some implementations, an example of a retrofitted air register 300 may include the conventional air register 120 retrofitted with a damper control system 350. The conventional air register 120 may include the first set of dampers 122 (not shown), the second set of dampers 124, one or more brackets 126, a surface 128, a manual lever 130 connected to a damper adjustment linkage assembly 131, a plurality of rotatable connectors 132, and a bar 134. The second set of dampers 124 may extend between and be rotatably coupled with the one or more brackets 126 via the plurality of rotatable connectors 132. The second set of dampers 124 may be rotated into a closed position parallel to the surface 128 to substantially obstruct air flow through the conventional air register 120 and into an open position perpendicular to the closed position to allow air flow through the conventional air register 120. The second set of dampers 124 may be movably coupled (e.g., via one or more links and rotatable connectors) with the bar 134 that forms part of the damper adjustment linkage assembly 131, which is movably controlled in a conventional register by the manual lever 130. When the bar 134 is in a first position, the second set of dampers 124 may be in the closed position. When the bar 134 is in a second position the second set of dampers 124 may be in the open position. The second set of dampers 124, the manual lever 130, and the bar 134 may be portions of the damper adjustment linkage assembly 131.

In some implementations, the conventional air register 120 may be retrofitted with the damper control system 350. The damper control system 350 may be detachably coupled with the conventional air register 120. For example, the damper control system 350 may be coupled with one of the surfaces of a body 121 of the conventional air register 120, such as the surface 128, using adhesive such as glue, cement, paste, epoxy, adhesive tapes, or double sided tapes. In another example, the damper control system 350 may be coupled with the conventional air register 120 using one or more internal and/or external magnets. The one or more internal magnets may magnetically couple with the conventional air register 120. In yet another non-limiting example, the damper control system 350 may be coupled with the conventional air register 120 using one or more fasteners such as bolts, screws, nails, buckles, buttons, ties, clamps, clasps, clips, pins, hooks, latches, pegs, rings, rivets, anchors, staples, or straps.

In some aspects, the damper control system 350 may include a casing 352, an actuating linkage assembly 354, a motor assembly 360, a battery compartment 370, and a microcontroller 380. The casing 352 defines a housing that may contain the motor assembly 360, the battery compartment 370, the microcontroller 380 and/or other components. The casing 352 may include a slim profile to minimize obstruction to the air flow through the conventional register 120. The actuating linkage assembly 354 may include one or more links, such as link 355 rotatably connected with link 357, that movably connect an output (e.g., a rotating shaft 359) of the motor assembly 360 with the manual lever 130 or another component of the damper adjustment linkage assembly 131. For example, in one implementation, the actuating linkage assembly 354 may be configured such that link 355 is detachably and rotatably coupled with the bar 134 using one or more rotatable connectors, and link 357 is rotatably connected to link 355 at one end and fixedly connected at the opposite end to the shaft 359 of the motor assembly 360. The rotatable connectors may include, but are not limited to, hinges, pins, screws, rivets, or any other structure that allows a rotating connection. As such, when the shaft 359 rotates, the link 355 also rotates, which via the rotating connection causes link 355 to translate, which moves the bar 134 thereby causing the damper adjustment linkage assembly 131 to adjust a position of the second set of dampers 124. For example, the actuating linkage assembly 354 may operate between an extended position (as shown in FIG. 3) and a retracted position. In the extended position, the actuating linkage assembly 354 may actuate the bar 134 into the first position, causing the second set of dampers 124 to move into the closed position. In the retracted position, the actuating linkage assembly 354 may actuate the bar 134 into the second position, causing the second set of dampers 124 to move into the open position.

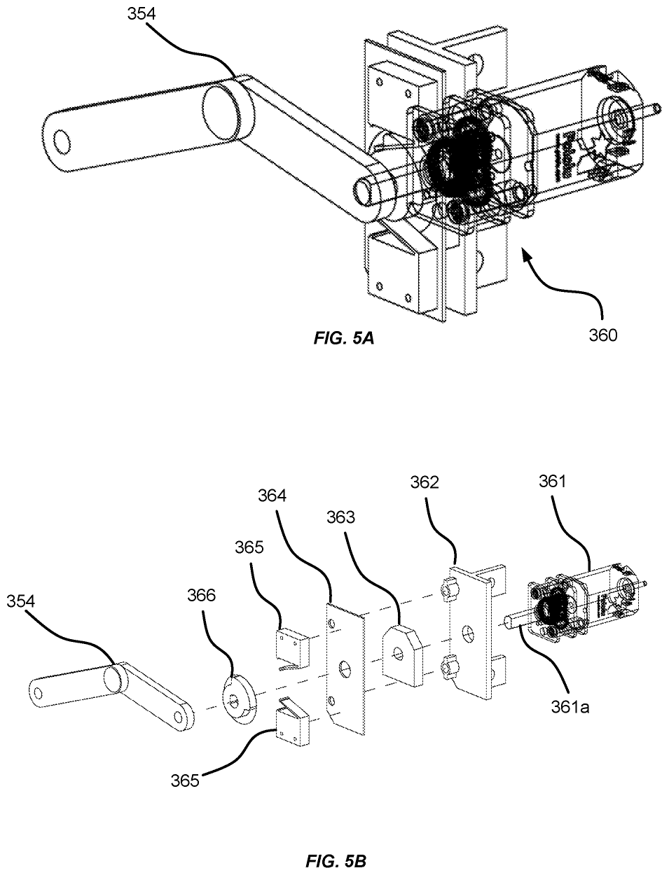

In some implementations, the motor assembly 360 may drive the actuating linkage assembly 354 between the extended position and the retracted position. Specifically, the motor assembly 360 may drive the actuating linkage assembly 354 anywhere from the extended position (including the extended position) to the retracted position (including the retracted position). A detailed description of the motor assembly 360 is presented below in conjunction with FIGS. 5A-B.

In some aspects, the damper control system 350 may be powered by one or more batteries 372 stored in a battery compartment 370 of the casing 352.

In some aspects, the damper control system 350 may be controlled by the microcontroller 380. For example, the microcontroller 380 may include one or more processors, a memory, and/or a communications circuit. In some implementations, the microcontroller 380 may optionally include one or more of an air pressure sensor, a temperature sensor, a humidity sensor, or a motion sensor. The microcontroller 380 may cause the motor assembly to drive the actuating linkage assembly 354 between the extended position and the retracted position. The microcontroller 380 may be integrated with the damper control system 350 or a standalone circuit. The handheld device 104 and/or the environment controller 106 may send one or more control signals to the microcontroller 380 of the damper control system 350. Upon receiving the one or more control signals, the microcontroller 380 may cause the motor assembly 360 to drive the actuating linkage assembly 354.

During an example of operation, the conventional air register 120 retrofitted with the damper control system 350 may be placed in a room, such as the room 110. The damper control system 350 may adjust the amount of air flowing through the conventional air register 120 by moving the second set of dampers 124. In a non-limiting example, the thermostat of the environment controller 106 may detect a temperature in the room 110 to be higher than a predetermine temperature. In response, the damper control system 350 may receive a signal from the environment controller 106 to actuate the actuating linkage assembly 354 to the retracted position to maximize the cool air flowing through the conventional air register 120 into the room 110. The signal may include an identifier associated with the conventional air register 120 and/or the damper control system 350.

In another example, the person 102 may decide that the temperature in the room is slightly too low for his or her liking. In response, the damper control system 350 may receive one or more control signals from the handheld device 104 (controlled by the person 102) to actuate the actuating linkage assembly 354 from the extended position to a position between the extended position and the retracted position to increase the warm air flowing through the conventional air register 120 into the room 110. In some examples, the damper control system 350 may actuate the actuating linkage assembly 354 to the extended position shut off the air flowing through the conventional air register 120 into the room 110 at a given time of day (e.g., turning off air conditioning after 6:00 pm).

In other examples, the damper control system 350 may utilize the communications circuit in the microcontroller 380 to wirelessly communicate with the handheld device 104 and/or the environment controller 106. The communications circuit may include one or more antennas or antenna arrays, transceivers, receivers, transmitters, power amplifiers, low noise amplifiers, and/or modems. In an implementation, the microcontroller 380 of the damper control system 350 may transmit, via the communications circuit, a low battery signal to the handheld device 104 indicating that the one or more batteries 372 have reached a low battery status.

In another example, the microcontroller 380 of the damper control system 350 may receive, via the communications circuit, configuration information, software update information, intrusion alerts, or other information from the handheld device 104, the environment controller 106, or other suitable systems.

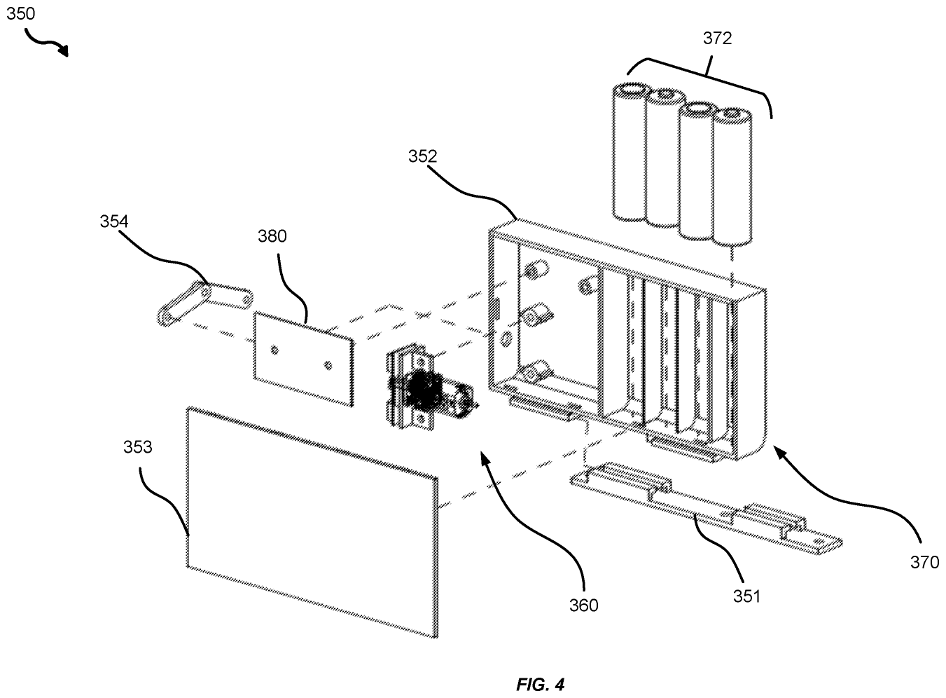

Turning now to FIG. 4, an exploded view of the damper control system 350 may include a base 351, the casing 352, a casing cover 353, the actuating linkage assembly 354, the motor assembly, the battery compartment 370, and the microcontroller 380. In a non-limiting example, the casing 352 may be detachably coupled with the base 351. The base 351 may be coupled with one of the surfaces of the conventional air register 120, such as the surface 128, using adhesive such as glue, cement, paste, epoxy, adhesive tapes, or double sided tapes. In another example, the base 351 may be coupled with the conventional air register 120 using one or more internal magnets. The one or more internal magnets may magnetically couple with the conventional air register 120. In yet another non-limiting example, the base 351 may be coupled with the conventional air register 120 using one or more fasteners such as bolts, screws, nails, buckles, buttons, ties, clamps, clasps, clips, pins, hooks, latches, pegs, rings, rivets, anchors, staples, or straps.

In certain aspects, the casing cover 353 may encapsulate the motor assembly 360, the one or more batteries 372, and the microcontroller 380 in the casing 352. The one or more batteries 372 may provide electrical energy to the microcontroller 380 and/or the motor assembly 360.

Turning now to FIG. 5A, the motor assembly 360 may drive the actuating linkage assembly 354 between the extended position and the retracted position. The actuating linkage assembly 354 may operate in the extended position (as shown in FIG. 3), the retracted position, and a position between the extended position and the retracted position. In the extended position, the actuating linkage assembly 354 may actuate the bar 134 into the first position. In the retracted position, the actuating linkage assembly 354 may actuate the bar 134 into the second position. The motor assembly 360 may drive the actuating linkage assembly 354 to a plurality of positions between (inclusive) the extend position and the retracted position.

Turning now to FIG. 5B, the motor assembly 360 may include a motor 361 coupled with a motor mounting base 362. The motor 361 may include a motor shaft 361a. The motor assembly 360 may include a potentiometer 363 and a circuit board 364 configured to provide feedback information relating to the position of the actuating linkage assembly 354 (e.g., extended, retracted, or in between). The motor assembly 360 may include a plurality of limit switches 365 and a rotary link 366.

During an example of operation, the motor 361 may axially turn the motor shaft 361a to actuate the actuating linkage assembly 354. As the motor shaft 361a turns, at least one of the potentiometer 363 or the rotary link 366 may turn correspondingly. The turning of the potentiometer 363 may signal the circuit board 364 the position of the actuating linkage assembly 354. For example, when the potentiometer 363 is turned to a first radial position (i.e., having a first resistance), the actuating linkage assembly 354 may be in the extended position, and the second set of dampers 124 may be in the closed position. The circuit board 364 may measure the first resistance of the potentiometer 363 and determine that the second set of dampers 124 are in the closed position. In another example, when the potentiometer 363 is turned to a second radial position (i.e., having a second resistance), the actuating linkage assembly 354 may be in the retracted position, and the second set of dampers 124 may be in the open position. The circuit board 364 may measure the second resistance of the potentiometer 363 and determine that the second set of dampers 124 are in the open position.

In other examples, as the motor shaft 361a turns, the rotary link 366 may turn correspondingly. The plurality of limit switches 365 may limit the rotation of the rotary link 366, and consequently, limiting the rotation of the motor shaft 361a. The limiting of the rotation of the motor shaft 361a may limit the motion of the actuating linkage assembly 364 between the extended position and the retracted position.

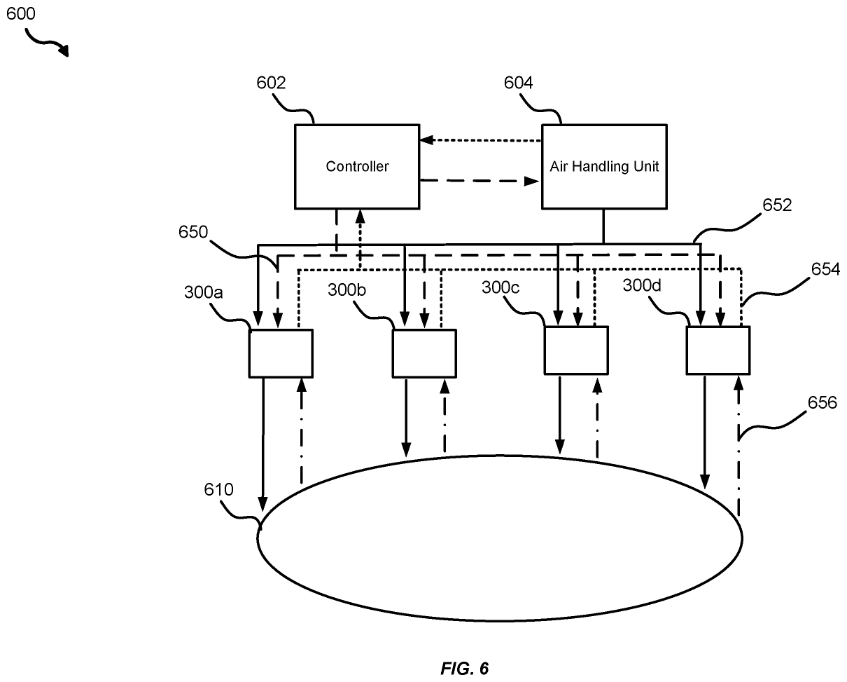

Turning to FIG. 6, in some implementations, an example of an environment 600 for implementing retrofitted air registers may include a controller 602, an air handling unit 604, a plurality of retrofitted air registers 300a-d, and one or more structures 610. The controller 602 may be implemented based on at least one of the handheld device 104 and/or the environment controller 106. The air handling unit 604 may be configured to provide room-temperature air, cool air, and/or warm air. The one or more structures 610 may include one or more rooms, halls, compartments, warehouses, closets, or other structures.

During an example of operation, the controller 602 (e.g., the handheld device 104 or the environment controller 106) may transmit one or more control signals 650 to the air handling unit 604 to activate the flow of room-temperature air, cool air, and/or warm air. The controller 602 may transmit may transmit the one or more control signals 650 to the plurality of retrofitted air registers 300a-d to open/close the respective second sets of dampers 124 to allow more/less air flow 652 (e.g., room-temperature air, humidified air, filtered air, cool air, and/or warm air) from the air handling unit 604 to the one or more structures 610 via the plurality of retrofitted air registers 300a-d.

In some aspects, the plurality of retrofitted air registers 300 a-d may rely on sensors in the microcontroller 380 (e.g., an air pressure sensor, a temperature sensor, a humidity sensor, or a motion sensor) to collect environmental information 656 relating to the one or more structures 610. Alternatively, the sensors may be elsewhere within the casing 352. For example, the retrofitted air register 300a may measure the air pressure with the air pressure sensor. The retrofitted air register 300b may measure the temperature with the temperature sensor. The retrofitted air register 300c may measure the humidity with the humidity sensor. The retrofitted air register 300d may detect the presence of occupant in the one or more structures 610 with the motion sensor. Based on the measured/detected environmental information 656, the plurality of retrofitted air registers 300 a-d may provide one or more feedback signals 654 to the controller 602. The one or more feedback signals 654 may include pressure, temperature, humidity values, and/or a positive detection signal. In some implementations, each of the plurality of retrofitted air registers 300 a-d may include one or more of the air pressure sensor, the temperature sensor, the humidity sensor, or the motion sensor.

In an example, the retrofitted air register 300c may measure a temperature of 30° C. in the one or more structures 610. The retrofitted air register 300c may utilize the respective microcontroller 380 to transmit the temperature information to the controller 602. The controller 602 (e.g., the handheld device 104, the environment controller 106, and/or applications installed in the handheld device 104 or the environment controller 106), in response to receiving the temperature information, may transmit the one or more control signals 650 to the air handling unit 604 to increase the air flow 652 (e.g., cool air) and/or to one or more of the plurality of retrofitted air registers 300 a-d to open the respective second set of dampers 124 to lower the temperature in the one or more structures 610.

In another non-limiting example, the retrofitted air register 300a may measure a relative humidity of 10% in the one or more structures 610. The retrofitted air register 300a may utilize the respective microcontroller 380 to transmit the humidity information to the controller 602. The controller 602 (e.g., the handheld device 104, the environment controller 106, and/or applications installed in the handheld device 104 or the environment controller 106), in response to receiving the humidity information, may transmit the one or more control signals 650 to the air handling unit 604 to increase the air flow 652 (e.g., humidified air) and/or to one or more of the plurality of retrofitted air registers 300 a-d to open the respective second set of dampers 124 to increase the humidity in the one or more structures 610.

In an implementation, the retrofitted air register 300d may detect a person in the one or more structures 610. The retrofitted air register 300d may utilize the respective microcontroller 380 to transmit the detection information to the controller 602. The controller 602 (e.g., the handheld device 104, the environment controller 106, and/or applications installed in the handheld device 104 or the environment controller 106), in response to receiving the detection information, may transmit the one or more control signals 650 to the air handling unit 604 to increase the air flow 652 (e.g., warm air) and/or to one or more of the plurality of retrofitted air registers 300 a-d to open the respective second set of dampers 124 to increase the temperature in the one or more structures 610.

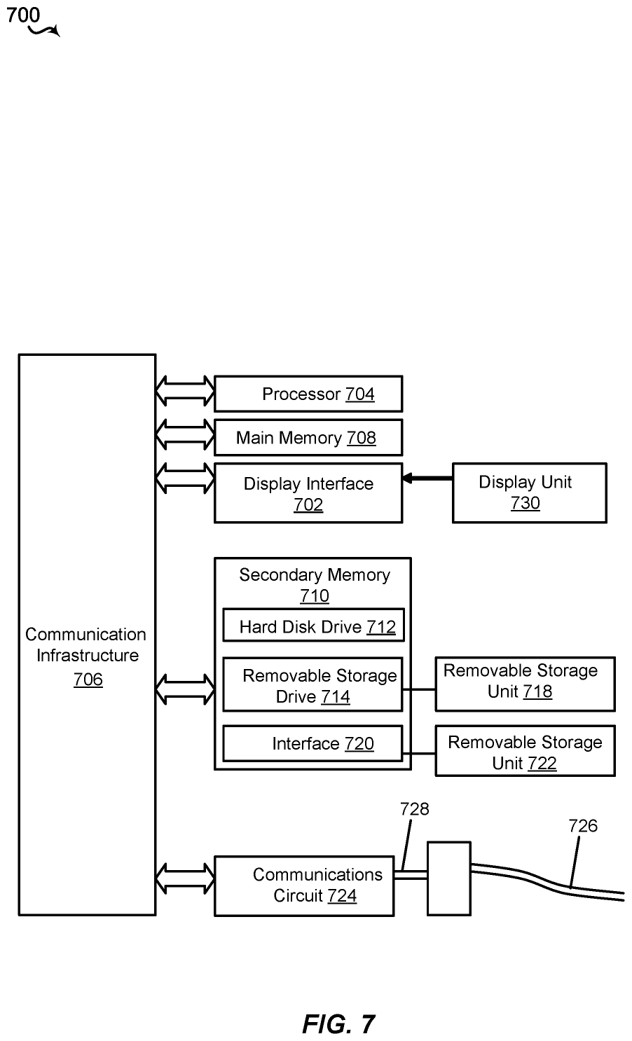

Aspects of the present disclosures may be implemented using hardware, software, or a combination thereof and may be implemented in one or more computer systems or other processing systems. In an aspect of the present disclosures, features are directed toward one or more computer systems capable of carrying out the functionality described herein. An example of such the computer system 700 is shown in FIG. 7. In some examples, the handheld device 104 may be implemented as the computer system 700 shown in FIG. 7. The handheld device 104 may include some or all of the components of the computer system 700. In some aspects, the microcontroller 380 of the damper control system 350 may be implemented as the computer system 700 shown in FIG. 7. The microcontroller 380 may include some or all of the components of the computer system 700.

The computer system 700 includes one or more processors, such as processor 704. The processor 704 is connected with a communication infrastructure 706 (e.g., a communications bus, cross-over bar, or network). Various software aspects are described in terms of this example computer system. After reading this description, it will become apparent to a person skilled in the relevant art(s) how to implement aspects of the disclosures using other computer systems and/or architectures.

The computer system 700 may include a display interface 702 that forwards graphics, text, and other data from the communication infrastructure 706 (or from a frame buffer not shown) for display on a display unit 730. Computer system 700 also includes a main memory 708, preferably random access memory (RAM), and may also include a secondary memory 710. The secondary memory 710 may include, for example, a hard disk drive 712, and/or a removable storage drive 714, representing a floppy disk drive, a magnetic tape drive, an optical disk drive, a universal serial bus (USB) flash drive, etc. The removable storage drive 714 reads from and/or writes to a removable storage unit 718 in a well-known manner. Removable storage unit 718 represents a floppy disk, magnetic tape, optical disk, USB flash drive etc., which is read by and written to removable storage drive 714. As will be appreciated, the removable storage unit 718 includes a computer usable storage medium having stored therein computer software and/or data. In some examples, one or more of the main memory 708, the secondary memory 710, the removable storage unit 718, and/or the removable storage unit 722 may be a non-transitory memory.

Alternative aspects of the present disclosures may include secondary memory 710 and may include other similar devices for allowing computer programs or other instructions to be loaded into computer system 700. Such devices may include, for example, a removable storage unit 722 and an interface 720. Examples of such may include a program cartridge and cartridge interface (such as that found in video game devices), a removable memory chip (such as an erasable programmable read only memory (EPROM), or programmable read only memory (PROM)) and associated socket, and other removable storage units 722 and interfaces 720, which allow software and data to be transferred from the removable storage unit 722 to computer system 700.

Computer system 700 may also include a communications circuit 724. The communications circuit 724 may allow software and data to be transferred between computer system 700 and external devices. Examples of the communications circuit 724 may include a modem, a network interface (such as an Ethernet card), a communications port, a Personal Computer Memory Card International Association (PCMCIA) slot and card, etc. Software and data transferred via the communications circuit 724 are in the form of signals 728, which may be electronic, electromagnetic, optical or other signals capable of being received by the communications circuit 724. These signals 728 are provided to the communications circuit 724 via a communications path (e.g., channel) 726. This path 726 carries signals 728 and may be implemented using wire or cable, fiber optics, a telephone line, a cellular link, an RF link and/or other communications channels. In this document, the terms “computer program medium” and “computer usable medium” are used to refer generally to media such as a removable storage drive 718, a hard disk installed in hard disk drive 712, and signals 728. These computer program products provide software to the computer system 700. Aspects of the present disclosures are directed to such computer program products.

Computer programs (also referred to as computer control logic) are stored in main memory 708 and/or secondary memory 710. Computer programs may also be received via communications circuit 724. Such computer programs, when executed, enable the computer system 700 to perform the features in accordance with aspects of the present disclosures, as discussed herein. In particular, the computer programs, when executed, enable the processor 704 to perform the features in accordance with aspects of the present disclosures. Accordingly, such computer programs represent controllers of the computer system 700.

In an aspect of the present disclosures where the method is implemented using software, the software may be stored in a computer program product and loaded into computer system 700 using removable storage drive 714, hard drive 712, or communications interface 720. The control logic (software), when executed by the processor 704, causes the processor 704 to perform the functions described herein. In another aspect of the present disclosures, the system is implemented primarily in hardware using, for example, hardware components, such as application specific integrated circuits (ASICs). Implementation of the hardware state machine so as to perform the functions described herein will be apparent to persons skilled in the relevant art(s).

In one non-limiting example, the handheld device 104 may be implemented as the computer system 700 having the one or more processor, the main memory 708, the display interface 702, the display unit 730, the communication infrastructure 706, and the communications circuit 724.

In other examples, the damper control system 350 may be implemented as the computer system 700 having the one or more processor, the main memory 708, and the communications circuit 724.

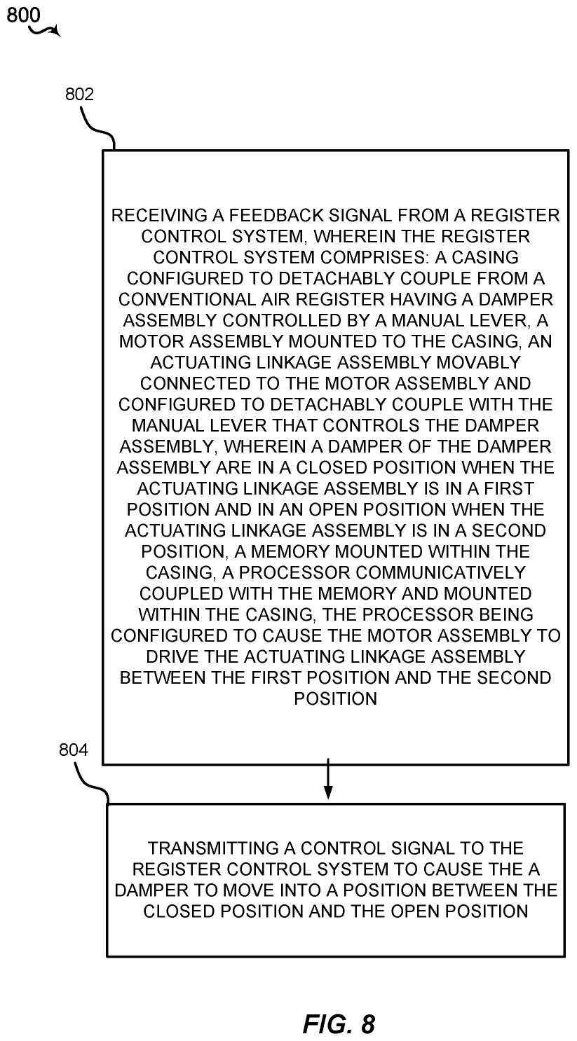

Turning now to FIG. 8, a method 800 for controlling the air flow of a retrofitted air register.

At block 802, the method 800 may receive a feedback signal from a damper control system, wherein the damper control system includes a casing configured to detachably couple with a conventional air register via one or more fasteners, an actuating linkage assembly coupled with a damper assembly, wherein one or more dampers of the damper assembly are in a closed position when the actuating linkage assembly is in a first position and in an open position when the actuating linkage assembly is in a second position, a motor assembly, a memory, and one or more processors operatively connected to the memory, the one or more processors being configured to cause the motor assembly to drive the actuating linkage assembly between the first position and the second position. For example, the communications circuit (e.g., the communications circuit 724) and/or the processor (e.g., the one or more processors 704) of the handheld device 104 may receive a feedback signal from the damper control system 350 including temperature information, humidity information, pressure information, or motion detection information of the one or more structures 610.

At block 804, the method 800 may transmit a control signal to the damper control system to cause the one or more dampers to move into a position between the closed position and the open position. For example, the communications circuit (e.g., the communications circuit 724) and/or the processor (e.g., the one or more processors 704) of the handheld device 104 may transmit a control signal to the damper control system 350 to move the second set of dampers 124 to move into a position between the closed position and the open position.

It will be appreciated that various implementations of the above-disclosed and other features and functions, or alternatives or varieties thereof, may be desirably combined into many other different systems or applications. Also that various presently unforeseen or unanticipated alternatives, modifications, variations, or improvements therein may be subsequently made by those skilled in the art which are also intended to be encompassed by the following claims.

What is claimed is:

1. A register control system, comprising:
a casing configured to detachably couple from a conventional air register having a damper assembly movably controllable by a manual lever;
a motor assembly mounted to the casing;
an actuating linkage assembly movably attached to the motor assembly and configured to detachably couple with the manual lever that controls the damper assembly, wherein a damper of the damper assembly is in a closed position when the actuating linkage assembly is in a first position and in an open position when the actuating linkage assembly is in a second position;
a memory mounted within the casing; and
a processor communicatively coupled with the memory and mounted within the casing, the processor being configured to cause the motor assembly to drive the actuating linkage assembly between the first position and the second position.

2. The register control system of claim 1, further comprising at least one of a temperature sensor, a motion sensor, an air pressure sensor, or humidity sensor.

3. The register control system of claim 1, further comprising a communications circuit, wherein the processor is configured to transmit, via the communications circuit, a feedback signal including at least one of temperature information, humidity information, pressure information, or motion detection information.

4. The register control system of claim 3, wherein the processor is configured to:
receive, via the communications circuit and in response to transmitting the feedback signal, a control signal indicating a position for the actuating linkage assembly between the first position and the second position; and
cause the motor assembly to drive the actuating linkage assembly to the position.

5. The register control system of claim 1, further comprising a battery compartment for storing a battery used to provide electrical energy to the register control system.

6. The register control system of claim 1, wherein the motor assembly includes a rotary link and at least one limit switch to limit a movement of the actuating linkage assembly.

7. The register control system of claim 1, wherein the damper assembly defines an airflow cross-sectional area of the conventional air register, and wherein the casing is configured to detachably couple with the conventional air register such that a corresponding cross-sectional area of the casing overlaps less than 10% of the airflow cross-sectional area.

8. An air register, comprising:
a body including a bracket;
a damper assembly mounted to the bracket and having a damper movably controllable by a manual lever; and
a register control system removably attachable to the body, the register control system including:
a casing configured to detachably couple from the body;
a motor assembly mounted to the casing;
an actuating linkage assembly movably attached to the motor assembly and configured to detachably couple with the manual lever of that controls the damper assembly, wherein the damper of the damper assembly are in a closed position when the actuating linkage assembly is in a first position and in an open position when the actuating linkage assembly is in a second position;
a memory mounted within the casing; and
processor communicatively coupled with the memory and mounted within the casing, the processor being configured to cause the motor assembly to drive the actuating linkage assembly between the first position and the second position.

9. The air register of claim 8, wherein the register control system includes at least one of a temperature sensor, a motion sensor, an air pressure sensor, or humidity sensor.

10. The air register of claim 8, wherein:
the register control system includes a communications circuit; and
the processor is configured to transmit, via the communications circuit, a feedback signal including at least one of temperature information, humidity information, pressure information, or motion detection information.

11. The air register of claim 10, wherein the processor is configured to:
receive, via the communications circuit and in response to transmitting the feedback signal, a control signal indicating a position for the actuating linkage assembly between the first position and the second position; and
cause the motor assembly to drive the actuating linkage assembly to the position.

12. The air register of claim 8, wherein the register control system includes a battery compartment for storing a battery used to provide electrical energy to the register control system.

13. The air register of claim 8, wherein the motor assembly includes a rotary link and at least one limit switch to limit a movement of the actuating linkage assembly.

14. The air register of claim 8, wherein the damper assembly defines an airflow cross-sectional area of the air register, and wherein the casing is configured to detachably couple with the air register such that a corresponding cross-sectional area of the casing overlaps less than 10% of the airflow cross-sectional area.

15. A method of controlling air flow, comprising:
receiving a feedback signal from a register control system, wherein the register control system comprises:
a casing configured to detachably couple from a conventional air register having a damper assembly controlled by a manual lever;
a motor assembly mounted to the casing;
an actuating linkage assembly movably connected to the motor assembly and configured to detachably couple with the manual lever that controls the damper assembly, wherein a damper of the damper assembly are in a closed position when the actuating linkage assembly is in a first position and in an open position when the actuating linkage assembly is in a second position;
a memory mounted within the casing; and
a processor communicatively coupled with the memory and mounted within the casing, the processor being configured to cause the motor assembly to drive the actuating linkage assembly between the first position and the second position; and
transmitting a control signal to the register control system to cause the a damper to move into a position between the closed position and the open position.

16. The method of claim 15, wherein the feedback signal comprises at least one of temperature information, humidity information, pressure information, or motion detection information.

17. The method of claim 16, wherein the control signal is transmitted in response to the at least one of temperature information, humidity information, pressure information, or motion detection information.

18. The method of claim 15, further comprises transmitting a second control signal to an air handling unit to change an air flow provided to the conventional air register by the air handling unit.

19. The method of claim 18, wherein the air flow includes dry air, humidified air, warm air, or cool air.
